(19) United States
(12) Patent Application Publication
(10) Pub. No.: US 2014/0161393 A1
(43) Pub. Date: Jun. 12, 2014

(54) Plug-in terminal and electronic device having a plug-in terminal

(71) Applicant: MCQ TECH GmbH, Blumberg (DE)

(72) Inventors: Joachim Borst, Donaueschingen (DE); Hermann Stadler, Donaueschingen (DE); Winfried Gruber, Ostfildern (DE); Andreas Veit, Ostfildern (DE); Markus Cech, Ostfildern (DE)

(21) Appl. No.: 13/898,102

(22) Filed: May 20, 2013

(30) Foreign Application Priority Data
May 25, 2012 (DE) 10 2012 208 899.7

(51) Int. Cl. G02B 6/36; H01R 24/00

(52) U.S. Cl. CPC G02B 6/36; H01R 23/025
USPC 385/76; 439/620.22

(57) ABSTRACT

The invention relates to a plug-in terminal having terminal elements for the connection of at least one electrical or optical conductor and having first connecting elements for connecting the at least one electrical or optical conductor with an electronic device, wherein the plug-in terminal comprises a storage for data and that means for reading out and/or archiving data in the storage by means of the electronic device are provided, as well as an electronic device which can be configured by means of configuration data having a plug-in terminal removably arranged on it, wherein the plug-in terminal comprises a storage for the configuration data.

### CROSS REFERENCE TO RELATED APPLICATIONS

This patent application claims priority German Patent Application 10 2012 208 899.7, filed on May 25, 2012.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a plug-in terminal with novel connection characteristics an electronic device having said type of terminal.

2. Background of the Invention

The current state of knowledge is as follows.

A key aspect of electronic devices used today is their high adaptability to different uses. However, such adaptability entails that an optimal utilization of the capabilities of a given electronic device for a certain use generally requires that the device be configured for said purpose and that the associated configuration data be archived in a storage such that the electronic device can access it.

The configuration, especially of electronic devices used for industrial applications, has to be carried out by staff that is better qualified than the regular operators of the device and can be quite time-consuming.

This is especially irritating when a device has to be repaired or replaced due to a defect, since a replacement device has to be used in these cases, which in turn needs to be configured.

In order to avoid the expenditure of time and costs to the greatest possible extent, it is known to archive the configuration data on a removable storage medium, for example an SD card, which is removably arranged in the device. This makes it possible to carry out the configuration of a replacement device intended to perform the function of a defective device, by removing the removable storage medium from the device which is replaced by the replacement device and by inserting the removable storage medium into the replacement device. Normally, this process is much faster than a complete reconfiguration of the replacement device and can additionally be performed autonomously by staff with lower qualifications.

Although said approach theoretically resolves the problems discussed above, it has been shown in the practice that this is not the case. In the ensuing confusion associated with the failure of a device, it is often forgotten to actually remove the storage medium from the defective device. It only turns out that the storage medium was disposed of together with the defective device or sent for repair when the replacement device has arrived and the configuration data is to be incorporated, thus leaving no other alternative than to carry out an expensive reconfiguration after all.

Therefore, the task of the invention is to provide a possibility to archive configuration data of an electronic device on a replaceable data carrier which improves the actual availability of the configuration data in the event the device is replaced without losing the benefit of the easy-to-replace storage.

This task is solved with a plug-in terminal with the characteristics of claim 1 and an electronic device having a plug-in terminal removably arranged on it with the characteristics of claim 11. Advantageous embodiments of the invention are the object of the sub-claims.

### BRIEF SUMMARY OF THE INVENTION

In a preferred embodiment, A plug-in terminal comprising terminal elements for connecting at least one electrical or optical conductor, further comprising first connecting elements for connecting the at least one electrical or optical conductor with an electronic device, wherein the plug-in terminal comprises a storage for data and a means for reading out and/or archiving data in the storage by means of the electronic device.

The plug-in terminal as disclosed herein, wherein the means for reading out and/or archiving data in the storage by means of the electronic device are electrical and/or optical contacts arranged in the terminal.

The plug-in terminal as disclosed herein, wherein the means for reading out and/or archiving data in the storage by means of the electronic device is a wireless connection between the storage and the electronic device.

The plug-in terminal as disclosed herein, wherein the first connecting elements are plug pins.

The plug-in terminal as disclosed herein, wherein the first connecting elements are spring contacts.

The plug-in terminal as disclosed herein, wherein the first connecting elements are circuit board edge contacts.

The plug-in terminal as disclosed herein, wherein the storage further comprises a plug-in connection with the plug-in terminal.

The plug-in terminal as disclosed herein, wherein the plug-in storage is a memory card.

The plug-in terminal as disclosed herein, wherein the plug-in terminal further comprises electrical contacts to establish contact with the plug-in storage, said electrical contacts being electrically connected with second connecting elements for the connection with the electronic device.

The plug-in terminal as disclosed herein, wherein the electrical contacts to establish contact with the plug-in storage are each a single piece with a second connecting element for the connection with the electronic device.

The plug-in terminal as disclosed herein, wherein the one-piece electrical contacts and second connecting elements are stamped or stamped and bent parts.

The plug-in terminal as disclosed herein, wherein the storage can be plugged in one direction into the plug-in terminal, which comprises at least one component oriented against the plug-in direction of the plug-in terminal.

The plug-in terminal as disclosed herein, wherein the storage can be plugged into the plug-in terminal from outside through an opening.

An electronic device which can be configured by means of configuration data, comprising a plug-in terminal removably arranged on it, wherein the plug-in terminal comprises a storage for the configuration data.

An electronic device which can be configured by means of configuration data, comprising a the plug-in terminal as disclosed herein, removably arranged on it.

### BRIEF DESCRIPTION OF THE DRAWINGS

FIG. 1 is a line drawing evidencing a representation of the exemplary embodiment of the invention with the plug-in storage not plugged in.

FIG. 2 is a line drawing evidencing the exemplary embodiment of the invention according to FIG. 1 with the plug-in storage plugged in.

FIG. 3 is a line drawing evidencing a section through the representation of FIG. 2 near the retainer for the plug-in storage; and

FIG. 4 is a line drawing evidencing a section through the representation of FIG. 2 near a connecting terminal.

### DETAILED DESCRIPTION OF THE INVENTION

The plug-in terminal according to the invention comprises terminal elements to connect at least one electrical or optical conductor and first connecting elements to link at least one electrical or optical conductor with an electronic device.

It is essential to the invention that the plug-in terminal has a data storage and that means for reading out and/or archiving data in the storage by means of the electronic device are provided.

The invention is based on the knowledge that in the majority of cases when a device is exchanged, be it for the purpose of its disposal or its repair, only the device itself, but not its connections with other devices with which it communicates and/or interacts, or its connections to the power supply are removed from the location where the device is used.

Therefore, the creation of the possibility achieved with the distinguishing characteristics of claim 1 to store the configuration data in a plug-in terminal which is in many cases available for the communication of the electronic device with the outside world and/or for its power supply anyway, and which remains connected with the connecting cables when the device is exchanged, the availability of configuration data for replacement devices can be improved significantly.

In an advantageous embodiment, the means for reading out and/or archiving data in the storage by means of the electronic device can be created as electrical and/or optical contacts arranged in the terminal. Consequently, the electronic device accesses the storage via the terminal, wherein an electrical or optical data transmission between the electronic device and the terminal and an electrical or optical data transmission between the terminal and the storage is essentially possible.

According to an advantageous embodiment of the invention, the means are formed as a wireless connection between the storage and the electronic device, for example based on RFID technology or in the form of an optical connection. This also allows the direct communication between the electronic device and the storage.

Depending on the nature and purpose of the electrical or electronic device, it is advantageous if the first connecting elements are created as plug pins, as spring contacts or as circuit board edge contacts.

The storage can basically be provided rigidly mounted on or in the terminal, but it has proven to be especially beneficial if the storage is connected with the terminal removable, in particular pluggable. This ensures the easy replaceability of the storage, for example in the event that the device configuration has to be replaced with a new one.

The storage can basically be designed as a component, an assembly or a memory card. However, a replaceable, plug-in storage can be realized in a particularly simple fashion if it is designed as memory card.

In a particularly preferred upgrade of the invention, the plug-in terminal has electrical contacts to establish contact with the plug-in storage, which are electrically connected with second connecting elements for the connection with the electronic device. This helps keep the interface to the electronic device simple.

A preferred upgrade of this aspect provides that the electrical contacts for establishing contact with the plug-in storage are each designed as a single piece with a second connecting element for the connection with the electronic device. This helps minimize the risk of contact losses. This can be achieved in a particularly economical fashion if the electrical contacts designed as a single piece and the second connecting elements are stamped or stamped and bent parts.

The unauthorized removal of a plug-in storage can be prevented if the storage can be plugged into the plug-in terminal in a direction which (from a vectorial view) comprises at least one component which is oriented against the plug-in direction of the plug-in terminal, i.e., against the direction in which the plug-in terminal is plugged onto the electronic component or device. As a result, the removal of the plug-in storage is prevented or at least constrained by the electronic component or device if the terminal is in plugged-in status. Ideally, the plug-in direction of the plug-in storage only comprises one component having said type of orientation.

Advantageously it is provided that the storage can be plugged into the plug-in terminal from the outside through an opening. Thereby it can be installed and accessed easily.

The electronic device according to the invention, which can be configured by means of configuration data and which has a plug-in terminal arranged on it, possesses a plug-in terminal having a storage for the configuration data, in particular a plug-in terminal according to the invention. In addition, we would like to point out that an electrical device can generally be considered an electronic component with other parts attached on it.

Aside from the possible upgrades of the plug-in terminal mentioned above, all of which are directly transferable, a preferred embodiment of said type of electronic component provides that the storage for configuration data the plug-in terminal comprises is the only storage for configuration data and hence the storage for configuration data to be provided on the electronic device according to the prior art is not required.

### DETAILED DESCRIPTION OF THE FIGURES

Since all figures relate to the same exemplary embodiment, identical reference numbers are used in all figures, although not all reference numbers were included in all the figures to improve the clarity and to make it easier to focus on essential aspects of the respective figures.

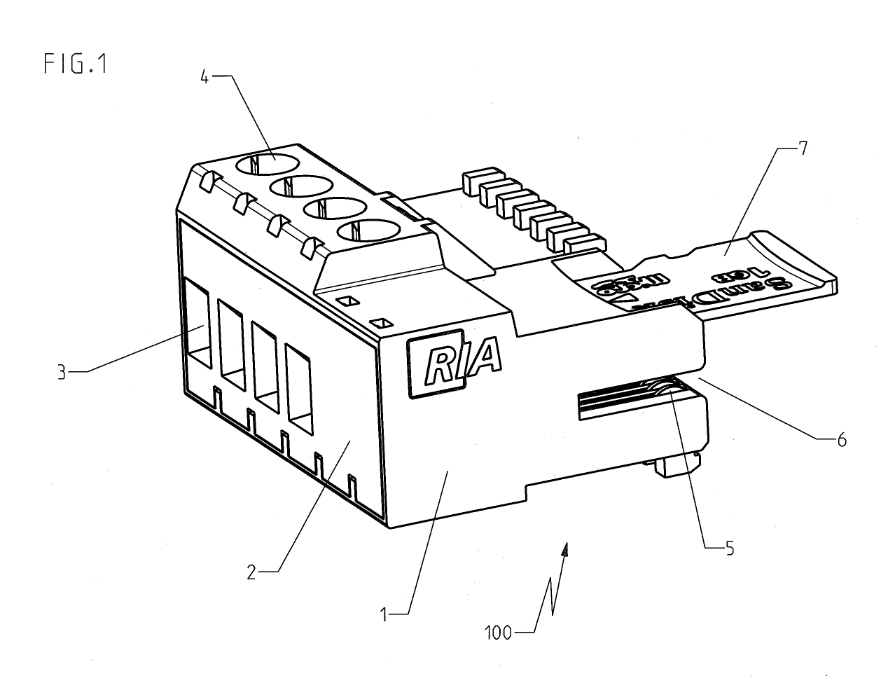

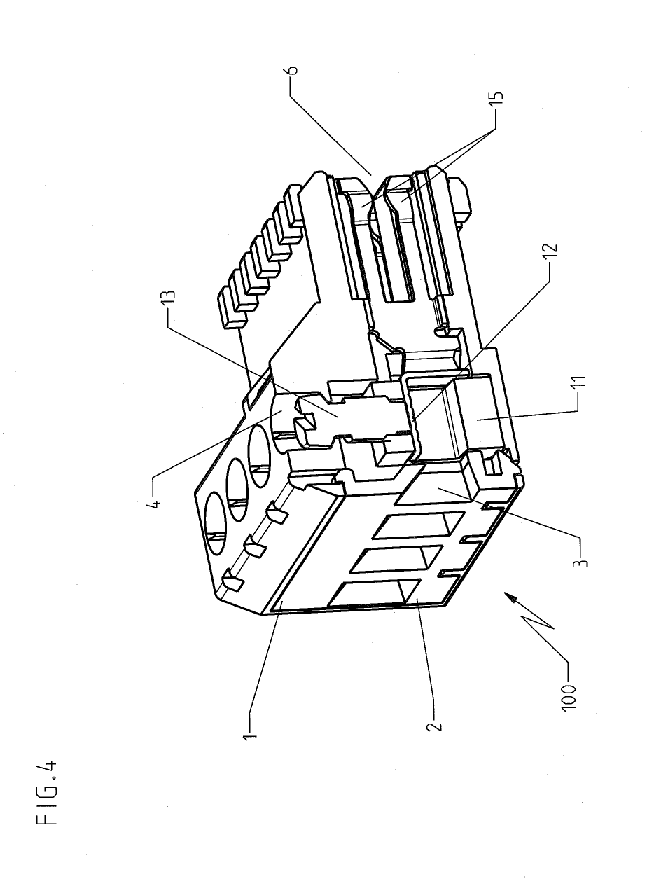

FIG. 1 shows a plug-in terminal 100 having a terminal casing 1 with a lid 2, which comprises four wire insertion openings 3 arranged side by side. Furthermore, the terminal casing 1 comprises four openings 4 for locking screws 13 which are only illustrated in FIG. 4. The openings 4 are perpendicular to the wire insertion openings 3 and are each assigned to one of the wire insertion openings 3.

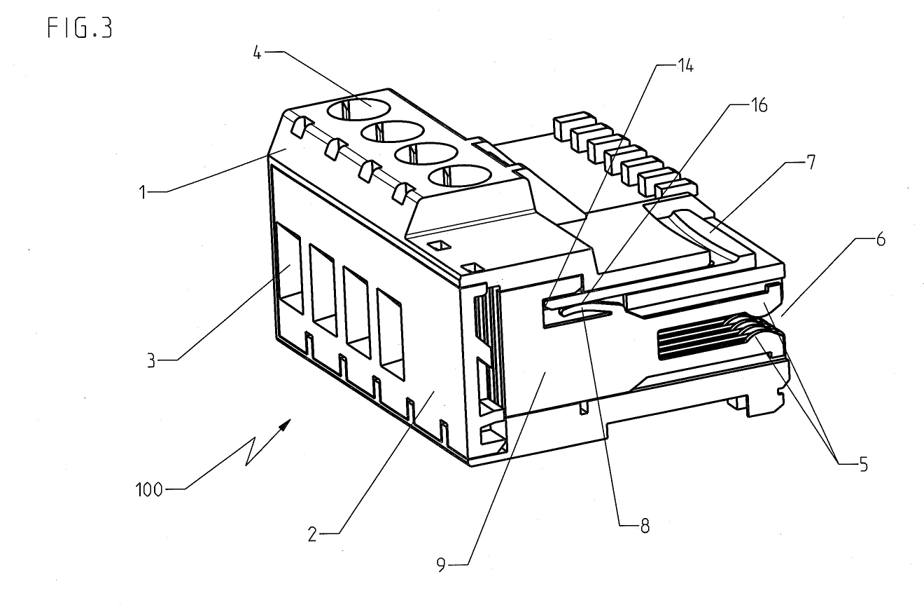

On the opposing side of the lid 2, the plug-in terminal 100 comprises a slit-like opening 6 for the retention of a not illustrated circuit board of an electronic device having circuit board edge contacts. The conductive connection with the circuit board edge contacts of the circuit board, if it is inserted into the slit-like opening 6, is established by way of connecting elements 5, 15, designed here as contact springs and arranged on the inner wall surfaces of the slit-like opening 6. As particularly well discernible in the sectional view of FIG. 3, a retaining shaft 14 for a storage 7 for data, designed here as SD memory card and hence plug-in type, is arranged parallel to and extending above the slit-like opening 6. Advantageously, the retaining shaft 14 is accessible from the outside through an opening, such that the storage 7 can be plugged into the plug-in terminal, in particular the retaining shaft 14 of the plug-in terminal from the outside through the opening.

As a consequence of said arrangement, the plug-in storage 7 is plugged in opposite to the plug-in direction of the plug-in terminal 100 and as a result, the plug-in storage 7 can only be removed with considerable effort when the terminal 100 is plugged in.

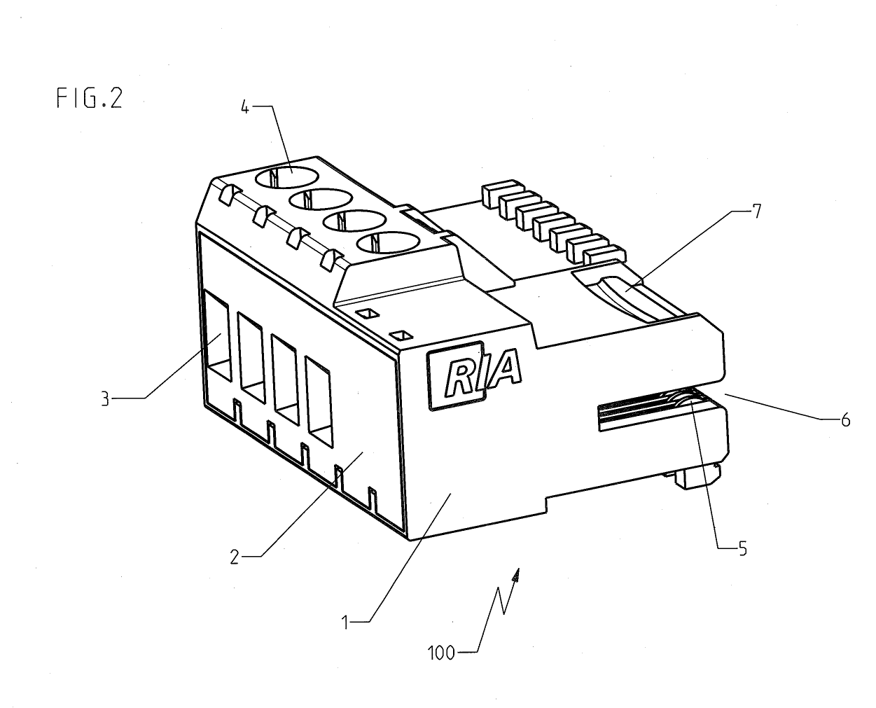

The only difference between the illustration of the plug-in terminal 100 according to FIG. 2 and its illustration in FIG. 1 is that the storage 7 for data designed as memory card is illustrated in the inserted status, in which it can be read out and is recordable.

The sectional view of FIG. 3 illustrates particularly clearly how the connection to the read and/or write access of the not illustrated circuit board to data is created here in the storage 7 designed as SD card by means of the second connecting elements 5.

A contact spring 8 is provided for this purpose, which establishes an electrically conductive connection between a contact area 16 provided on the storage 7 and the second connecting elements 5 which are likewise designed as contact springs. In the embodiment illustrated in FIG. 3, both the contact spring 8 as well as the second connecting elements 5 are formed with parts of a single contact 9 and are hence connected with each other as a single piece.

We would like to point out explicitly that a wireless connection for instance based on the RFID technology or an optical connection between the circuit board of an electronic device and the storage 7 can be generally provided instead of the second connecting elements 5.

For completeness' sake, the functionality of the plug-in terminal 100 with respect to the connection of not illustrated data and/or supply lines with the not illustrated circuit board is briefly explained based on the sectional representation according to FIG. 4. The not illustrated data and/or supply lines are inserted into the respective wire insertion openings 3 with a non-insulated end section and fastened there by means of the locking screws 13 arranged each in the respective openings 4. For this purpose, the locking screws 13 are screwed in further into a clamping body 11 through the openings 4, whereby the clamping body 11 is pulled in the direction toward the head of the locking screw 13 because the head of the locking screw 13 knocks against the opening 4 and hence the end section of the data and/or supply line is clamped into position between a sliding bow 12, which rests on the end of the locking screw 13 facing away from the head of the locking screw 13, and the clamping body 11. The sliding bow 12 has an electrically conductive connection with the first connecting elements 15; in the illustration of FIG. 4, both are connected with each other as a single piece and are each designed as sections of a stamped and bent part.

Consequently, an electrically conductive connection is established between circuit board edge contacts of a not illustrated circuit board inserted into the slit-like opening 6 and the data and/or supply lines by way of the first connecting elements 15 and the sliding bow 12, wherein the clamping body 11, sliding bow 12 and locking screw 13 interact as exemplary embodiment of a terminal element.

### LIST OF REFERENCE NUMBERS

1 Terminal casing

2 Lid for the terminal casing

3 Wire insertion opening

4 Opening for the locking screw

5 Second connecting element

6 Slit-like opening

7 Storage

8 Contact spring

9 Contact

11 Clamping body

12 Sliding bow

13 Locking screw

14 Retaining shaft

15 First connecting element

16 Contact area

100 Plug-in terminal

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A plug-in terminal comprising terminal elements for connecting at least one electrical or optical conductor, further comprising first connecting elements for connecting the at least one electrical or optical conductor with an electronic device, wherein the plug-in terminal comprises a storage for data and a means for reading out and/or archiving data in the storage by means of the electronic device.

2. The plug-in terminal of claim 1, wherein the means for reading out and/or archiving data in the storage by means of the electronic device are electrical and/or optical contacts arranged in the terminal.

3. The plug-in terminal of claim 1, wherein the means for reading out and/or archiving data in the storage by means of the electronic device is a wireless connection between the storage and the electronic device.

4. The plug-in terminal of claim 1, wherein the first connecting elements are plug pins.

5. The plug-in terminal of claim 1, wherein the first connecting elements are spring contacts.

6. The plug-in terminal of claim 1, wherein the first connecting elements are circuit board edge contacts.

7. The plug-in terminal of claim 1, wherein the storage further comprises a plug-in connection with the plug-in terminal.

8. The plug-in terminal of claim 7, wherein the plug-in storage is a memory card.

9. The plug-in terminal of claim 7, wherein the plug-in terminal further comprises electrical contacts to establish contact with the plug-in storage, said electrical contacts being electrically connected with second connecting elements for the connection with the electronic device.

10. The plug-in terminal of claim 9, wherein the electrical contacts to establish contact with the plug-in storage are each a single piece with a second connecting element for the connection with the electronic device.

11. The plug-in terminal of claim 10, wherein the one-piece electrical contacts and second connecting elements are stamped or stamped and bent parts.

12. The plug-in terminal of claim 7, wherein the storage can be plugged in one direction into the plug-in terminal, which comprises at least one component oriented against the plug-in direction of the plug-in terminal.

13. The plug-in terminal of claim 1, wherein the storage can be plugged into the plug-in terminal from outside through an opening.

14. An electronic device which can be configured by means of configuration data, comprising a plug-in terminal removably arranged on it, wherein the plug-in terminal comprises a storage for the configuration data.

15. An electronic device which can be configured by means of configuration data, comprising a the plug-in terminal of claim 1, removably arranged on it.
